(19) United States
(12) Patent Application Publication
(10) Pub. No.: US 2014/0101587 A1
(43) Pub. Date: Apr. 10, 2014

(54) INFORMATION PROCESSING APPARATUS AND METHOD

(71) Applicant: FUJI XEROX CO., LTD., Tokyo (JP)

(72) Inventor: Yoshihiro SEKINE, Kanagawa (JP)

(73) Assignee: FUJI XEROX CO., LTD., Tokyo (JP)

(21) Appl. No.: 13/889,938

(22) Filed: May 8, 2013

(30) Foreign Application Priority Data
Oct. 4, 2012 (JP) 2012-222304

(51) Int. Cl. G06F 3/0486; G06F 3/0488

(52) U.S. Cl. CPC G06F 3/0486; G06F 3/0488
USPC 715/769

(57) ABSTRACT

An information processing apparatus includes a display, a detector, a moving unit, an extracting unit, an approaching display unit, and an element processor. The display displays an image including elements on a display region of a display apparatus. The detector detects an operation in the display region. In response to detection of a first operation of moving a first element in the display region, the moving unit moves the first element in the display region. The extracting unit extracts a second element positioned in the direction of movement of the first element. The approaching display unit generates a third element relating to the second element and displays the third element at a position closer to the first element than the second element. In response to detection of a second operation on the third element, the element processor executes a process corresponding to the second operation on the second element.

### CROSS-REFERENCE TO RELATED APPLICATIONS

This application is based on and claims priority under 35 USC 119 from Japanese Patent Application No. 2012-222304 filed Oct. 4, 2012.

### BACKGROUND

1. Technical Field

The present invention relates to an information processing apparatus and method.

2. Summary

According to an aspect of the invention, there is provided an information processing apparatus including a display, a detector, a moving unit, an extracting unit, an approaching display unit, and an element processor. The display displays an image including the arrangement of multiple elements on a display region of a display apparatus. The detector detects an operation performed in the display region. In response to detection, by the detector, of a first operation in which a first element specified in the display region, among the elements displayed in the display region, is moved in the display region, the moving unit moves the first element in the display region in accordance with the first operation. The extracting unit extracts, from among the elements displayed in the display region, a second element positioned in the direction of movement of the first element. The approaching display unit generates a third element relating to the second element and displays the third element at a position closer to the first element than the second element. In response to detection, by the detector, of a second operation performed on the third element, the element processor executes a process corresponding to the second operation on the second element.

### BRIEF DESCRIPTION OF THE DRAWINGS

An exemplary embodiment of the present invention will be described in detail based on the following figures, wherein:

FIG. 1 is a diagram illustrating the external appearance of an information processing apparatus;

FIG. 2 is a diagram illustrating the hardware configuration of the information processing apparatus;

FIG. 3 is a diagram illustrating the functional configuration of the information processing apparatus;

FIG. 4 is a diagram illustrating a display region;

FIG. 5 is a diagram illustrating the arrangement of elements after an approaching display process is performed;

FIG. 6 is a flowchart illustrating the operation of the information processing apparatus;

FIG. 7 is a diagram illustrating the arrangement of elements after an approaching display process is performed;

FIG. 8 is a diagram illustrating the arrangement of elements after an approaching display process is performed;

FIG. 9 is a diagram illustrating the arrangement of elements after an approaching display process is performed; and

FIG. 10 is a diagram illustrating the arrangement of elements after an approaching display process is performed.

### DETAILED DESCRIPTION

### Configuration of Exemplary Embodiment

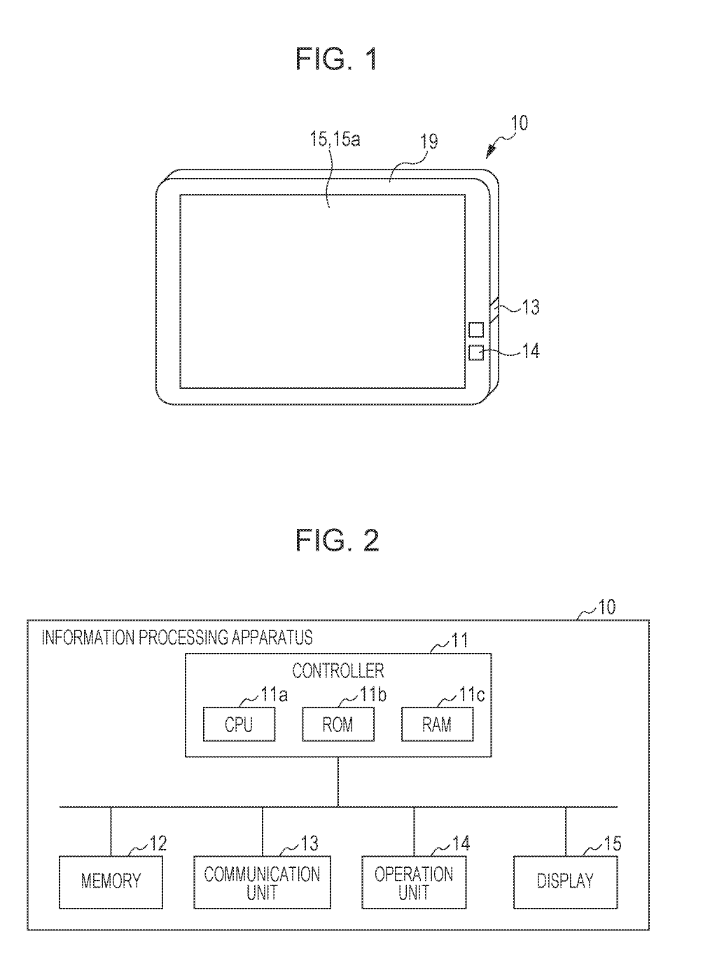

FIG. 1 is a diagram illustrating the external appearance of an information processing apparatus 10. FIG. 2 is a diagram illustrating the hardware configuration of the information processing apparatus 10. The information processing apparatus 10 is a computer with a touch panel type graphical user interface (GUI). The information processing apparatus 10 includes a controller 11, a memory 12, a communication unit 13, an operation unit 14, a display 15, and a housing 19.

The controller 11 includes an arithmetic unit such as a central processing unit (CPU) 11a, and storage devices such as a read-only memory (ROM) 11b and a random-access memory (RAM) 11c.

The memory 12 includes storage devices such as an electronically erasable and programmable read-only memory (EEPROM) and a static random-access memory (SRAM). The memory 12 stores an operating system (OS) and an application program. By executing these programs, the controller 11 controls the operation of the information processing apparatus 10.

The communication unit 13 includes communication interfaces such as Universal Serial Bus (USB) and a wireless local area network (LAN). In accordance with an operation accepted by the operation unit 14 or the display 15, the controller 11 communicates with another information processing apparatus via the communication unit 13.

The operation unit 14 includes an operator such as a power switch.

The display 15 is a display device using liquid crystal or organic electro-luminescence (EL) devices. The display 15 has a touch panel function, and detects an operation performed by a user on a display region 15a of the display 15. In accordance with the detected operation, the controller 11 causes the information processing apparatus 10 to operate.

The touch panel may by of any type, such as an electrostatic capacitance type, an electromagnetic induction type, a resistive film type, a surface acoustic wave (SAW) type, or an infrared type. The exemplary embodiment discusses an example in which a touch panel is of a type in which an operation is performed when the user touches the display region 15a with his/her finger or the like (such as an electrostatic capacitance type).

The display region 15a is a planar region whose outer edge is, for example, rectangular. The display region 15a may be of any size. Also, the information processing apparatus 10 may be of any configuration as long as the information processing apparatus 10 has a touch panel type GUI. For example, the information processing apparatus 10 may be an apparatus in which the size (the length of a diagonal) of the display region 15a ranges from a few inches to a dozen inches, which is referred to as a tablet personal computer (PC), or a large-size apparatus of a wall-hung type or a self-standing type placed on the floor, in which the size of the display region 15a ranges from a few tens of inches to a hundred and several tens of inches.

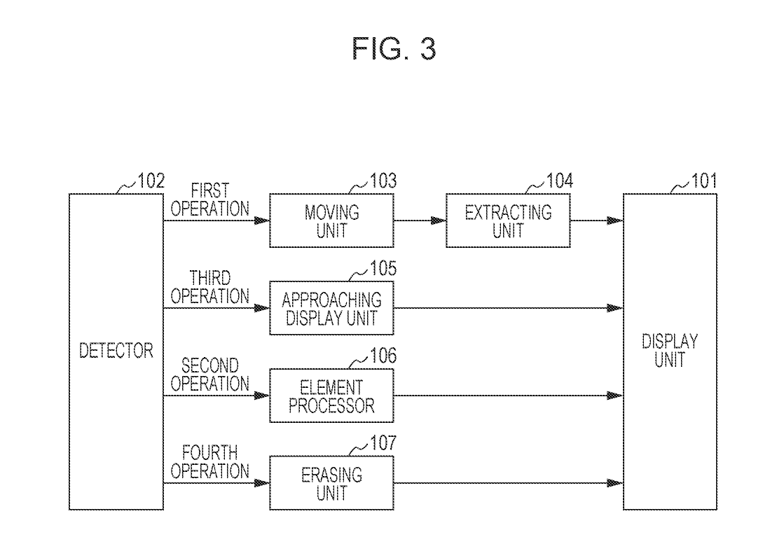

FIG. 3 is a diagram illustrating the functional configuration of the information processing apparatus 10. The functions of the information processing apparatus 10 are realized by executing, by the controller 11, the OS and application program stored in the memory 12.

A display unit 101 displays an image including the arrangement of multiple elements in the display region 15a of the display 15. Specific details are as follows.

The memory 12 stores desktop data that associates each of the elements to be displayed in the display region 15a with the position of that element in the display region 15a. The elements are icons, windows, and the like. On the basis of the desktop data, the controller 11 displays, in the display region 15a, an image representing a desktop in which these elements are arranged. In accordance with an operation performed in the display region 15a, the controller 11 updates the desktop data and updates the image in the display region 15a. Even when the power of the information processing apparatus 10 is turned off, the desktop data is continuously stored in the memory 12.

An icon represents a file, a folder (may also be referred to as a “directory”), an execution file of an application program, or a shortcut to the file or folder (may also be referred to as a “soft link” or “alias”) in picture. In the display region 15a, for example, the lattice points of a square lattice are virtually set (the lattice points are not displayed), and each icon is arranged so that the center of the icon is positioned at any of the lattice points. Also, icons are arranged not to overlap one another.

A window displays, when an element is a folder, a frame that represents the folder, and, within this frame, displays elements (icons, folders, execution files, shortcuts, or the like) associated with the folder as elements that belong to the folder.

Next, a detector 102 will be described.

The detector 102 detects an operation performed in the display region 15a. Specific details are as follows.

Major operations in the exemplary embodiment are drag, drop, tap, and double tap.

Dragging is an operation in which the user keeps touching, with his/her finger, an element displayed in the display region 15a and moves his/her finger in the display region 15a. An element moved by dragging will be referred to as a “first element”.

Dropping is an operation in which the user releases his/her finger from the first element moved by dragging. When dropping is performed, the first element is subjected to the following processing.

When the user's finger is released in a state in which the first element overlaps an element at the dragging destination, the controller 11 executes a process using the first element and the element at the dragging destination. The details of this process are determined in accordance with the attributes of the first element and the element at the dragging destination. For example, when the first element is the icon of a file and the element at the dragging destination is the icon of a folder, the file is moved to the interior of the folder. That is, the controller 11 associates the first element as an element that belongs to the element at the dragging destination, and erases the image of the first element from the display region 15a. When an operation of opening the element at the dragging destination (such as double tap) is performed, the controller 11 changes the element at the dragging destination from the icon to a window, and displays the first element in this window.

In contrast, when the user's finger is released in a state in which the first element is moved to another position in the background (portion where no element is displayed in the display region 15a), the controller 11 arranges the first element so that the center of the first element is positioned at a lattice point closest to the position where the user's finger is released.

Tapping is an operation in which the user hits the display region 15a with his/her finger. For example, when an element is tapped, the controller 11 recognizes that the element is selected, and changes the display status (tone, brightness, etc.) of this element.

Double tapping is an operation in which the user performs tapping twice within a determined time. A process to be performed in the case where an element is double-tapped is predetermined in accordance with the attribute of the element. For example, when the element is the icon of a file, the controller 11 executes an application program used to create that file, and displays the details of the file. When the element is the icon of an execution file, the controller 11 executes the execution file. A process to be performed in the case where double tap is performed in the background will be described later.

While the user's finger is touching the display region 15a, the display 15 periodically outputs contact position information representing the contact position of the finger to the controller 11. On the basis of the contact position information, the controller 11 specifies the details of the operation. For example, when the length of time in which the user's finger continuously touches the display region 15a is less than or equal to a first threshold, the controller 11 specifies that this operation is tapping. When the length of time between two consecutive taps is less than or equal to a second threshold, the controller 11 specifies that this operation is double tapping. When the length of time in which the user's finger continuously touches the display region 15a exceeds the first threshold, the controller 11 executes a process described later by using a function as a moving unit 103.

Next, the moving unit 103 will be described.

In response to detection, by the detector 102, of a first operation in which the first element specified in the display region 15a, among elements displayed in the display region 15a, is moved in the display region 15a, the moving unit 103 moves the first element in the display region 15a in accordance with the first operation. Specific details are as follows.

On the basis of the contact position information output from the display 15, the controller 11 moves the first element in the display region 15a. Since the contact position information is periodically output, the amount of displacement of the finger from a contact position at the time the contact position information is previously output is calculated every time the contact position information is output, and the first element is moved by the amount of displacement in the display region 15a. In short, the first element is dragged.

Whether dragging is stopped is determined on the basis of the speed of movement of the finger. Specifically, the controller 11 calculates the speed of movement of the finger from the contact position information, and, when the speed of movement that exceeds a threshold becomes less than or equal to the threshold, it is determined that dragging is stopped.

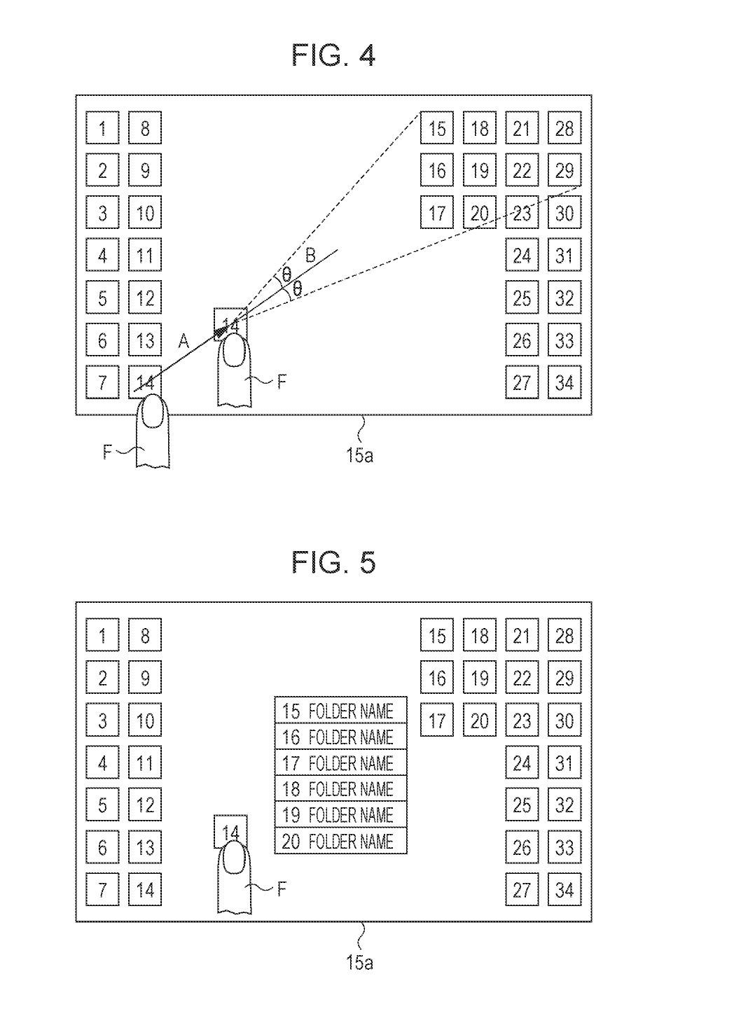

FIG. 4 is a diagram illustrating the display region 15a. A rectangle arranged in the display region 15a represents an element. A numeral (from 1 to 34) in the rectangle of each element is a numeral assigned to distinguish multiple elements in this description for the sake of explanatory convenience. Actually, a picture representing the type of each element and a unique name of that element are displayed. When an element is a file, a picture representing the type of that element is a picture symbolizing an application program used to create that file. When an element is a folder, a picture representing the type of that element is a picture symbolizing that folder. When an element is an execution file, a picture representing the type of that element is a picture symbolizing an application program of that execution file. Alternatively, when an element is a file, a picture that is a size-reduced image representing the details of that file (thumbnail) may be displayed. The unique name of each element is a file name, a folder name, an application program name, or the like.

In this example, finger F touches the 14th element, and the 14th element is moved as indicated by arrow A. In this case, the 14th element is the first element.

The first element may be continuously displayed not only at the position after the movement, but also at the position at which the first operation is started (position of the start point of arrow A).

Next, an extracting unit 104 will be described.

The extracting unit 104 extracts, from among elements displayed in the display region 15a, a second element positioned in the direction of movement of the first element. The extracting unit 104 also extracts, as a second element, an element that is positioned in the direction of movement of the first element and that corresponds to the attribute of the first element. Specific details are as follows.

As illustrated in FIG. 4, the controller 11 extracts an element positioned in a fan-shaped range, around the end point of arrow A, at an angle θ on both sides of extension B of arrow A. Here, the controller 11 may extract an element whose center is within the fan-shaped range, or may extract an element as long as the image of that element partially overlaps the fan-shaped range. In this example, it is assumed that an element is extracted in the former case, and the controller 11 extracts the 15th to 22nd, 28th, and 29th elements as elements positioned in the direction of movement of the first element.

The controller 11 also extracts, from among the extracted elements, an element corresponding to the attribute of the first element as a second element. For example, the attribute of the first element is the type of application program used to create the first element, and a folder including an element created by that application program is extracted as a second element. Here, the 15th to 20th elements are folders including elements created by that application program. If the 21st, 22nd, 28th, and 29th elements are not folders but are files, the 15th to 20th elements are extracted as second elements.

Next, an approaching display unit 105 will be described.

The approaching display unit 105 generates a third element relating to each second element, and displays the third element at a position closer to the first element than the second element. This process is referred to as an approaching display process. Specific details are as follows.

FIG. 5 is a diagram illustrating the arrangement of elements after an approaching display process is performed. The controller 11 generates a third element that is a duplicate of each second element extracted by using a function as the extracting unit 104, and displays the third element at a position closer to the first element than the second element. In this example, duplicates of the 15th to 20th elements are generated, and these duplicate elements are displayed at positions closer to the first element than the original elements. Also, the third elements are displayed so as not to overlap the first element. Also, the second elements are displayed at the same positions as before the approaching display process.

Also, in response to detection, by the detector 102, of a third operation after detection of the first operation, the approaching display unit 105 generates a third element, and displays the third element at a position closer to the first element than a corresponding one of the second elements. For example, when a period in which the user's finger continuously touches the first element after dragging (first operation) is stopped reaches a threshold (such as 0.5 seconds), the controller 11 determines that a third operation is performed, and executes an approaching display process.

Also, the approaching display unit 105 arranges third elements in the display region 15a in accordance with a predetermined rule. For example, third elements may be arranged in the reverse chronological order of update date. Alternatively, when third elements are folders, the third elements may be arranged in descending order of the number of files included in each folder. The direction of arranging third elements may be from top to bottom, or third elements may be arranged in another direction.

Also, in this example, the shape of each third element is transformed to be horizontally long and is displayed. In this way, when selecting a third element at the dropping destination, the user's eyes and finger move shorter than they do when third elements with their original shapes before the approaching display process are arranged. Alternatively, third elements may be displayed with the same shapes as those of the second elements.

Next, an element processor 106 will be described.

In response to detection, by the detector 102, of the second operation on a third element, the element processor 106 executes a process corresponding to the second operation on a corresponding one of the second elements. For example, the second operation is dropping as described above. When the first element is dropped to a third element, a process in accordance with the attributes of the first element and the third element is executed. For example, when the first element is the icon of a file and the third element is the icon of a folder, the file is moved to the interior of the folder. Here, visually, the first element is associated with the third element as an element that belongs to the third element. Actually, the controller 11 associates the first element with a corresponding one of the second elements, which is the original of the duplicate third element, as an element that belongs to the second element. In short, a process corresponding to the second operation is visually displayed as being executed on the third element, but is actually executed on the second element, which is the original of the duplicate third element.

Next, an erasing unit 107 will be described.

In response to detection, by the detector 102, of a fourth operation, the erasing unit 107 erases a third element from the display region 15a. The fourth operation is an operation of terminating the approaching display process, which is an operation in which, for example, the user taps the background while a third element is being displayed. In response to detection of the fourth operation, the controller 11 erases the third element from the display region 15a. Since the third element is a duplicate of a corresponding one of the second elements, the second element is not erased even when the third element is erased.

### Operation of Exemplary Embodiment

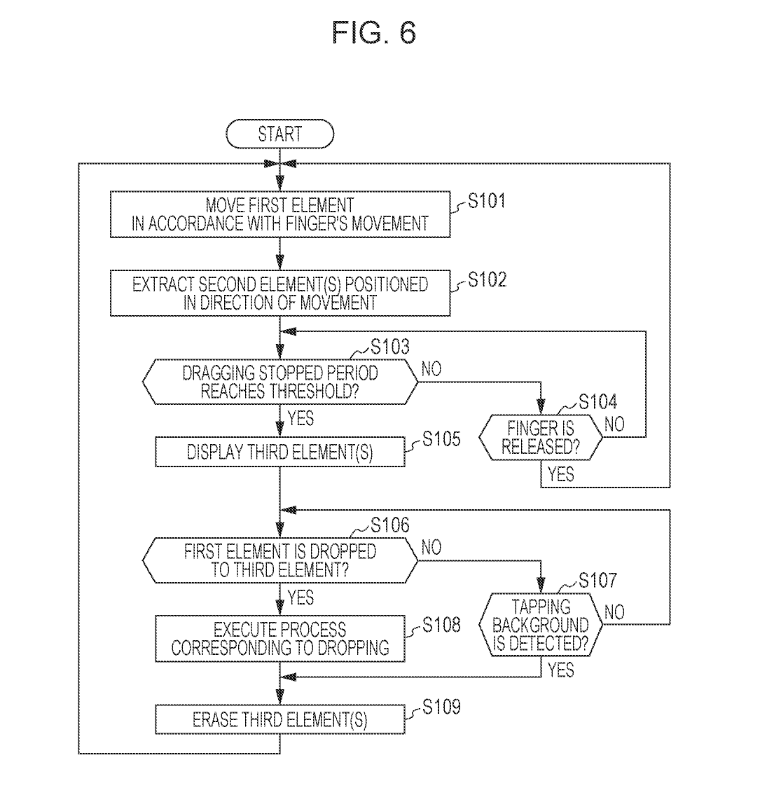

FIG. 6 is a flowchart illustrating the operation of the information processing apparatus 10. When power of the information processing apparatus 10 is turned on, the controller 11 executes the OS and application program, and controls the information processing apparatus 10 in accordance with the flowchart.

In step S101, the controller 11 detects an operation performed in the display region 15a by using a function as the detector 102. When dragging is detected, the controller 11 moves, by using a function as the moving unit 103, the first element in the display region 15a in accordance with dragging.

In step S102, the controller 11 extracts a second element positioned in the direction of movement of the first element by using a function as the extracting unit 104.

In step S103, the controller 11 determines whether the dragging stopped period reaches a threshold by using a function as the approaching display unit 105, and, when the stopped period reaches the threshold (YES in step S103), the process proceeds to step S105; when the stopped period does not reach the threshold (NO in step S103), the process proceeds to step S104.

In step S104, the controller 11 determines whether the finger is released from the display region 15a. When the finger is not released (NO in step S104), the process returns to step S103. When the finger is released (YES in step S104), the process returns to step S101. The controller 11 periodically repeats the processing in steps S103 and S104 until the determination in step S103 or S104 becomes YES.

In step S105, by using a function as the approaching display unit 105, the controller 11 generates a third element, displays the third element at a position closer to the first element than the second element, and arranges the third element in accordance with a predetermined rule.

In step S106, the controller 11 determines whether the first element is dropped to the third element. When the first element is dropped to the third element (YES in step S106), the process proceeds to step S108. When the first element is not dropped to the third element (NO in step S106), the process proceeds to step S107.

In step S107, the controller 11 determines whether tapping the background is detected by using a function as the detector 102. When tapping the background is detected (YES in step S107), the process proceeds to step S109. When tapping the background is not detected (NO in step S107), the process returns to step S106. The controller 11 periodically repeats the processing in steps S106 and S107 until the determination in step S106 or S107 becomes YES.

In step S108, the controller 11 executes a process corresponding to dropping.

In step S109, the controller 11 erases the third element by using a function as the erasing unit 107, and the process returns to step S101.

The operation of the information processing apparatus 10 is as described above.

In a display apparatus with a touch panel type GUI, when dragging an icon, the user may make a mistake in which the user's finger is released from the icon before dragging to a target place is completed, or the user may drag the icon to an unintended place. The larger the size of the screen becomes, inevitably the longer the distance of dragging becomes. Therefore, the user tends to make such mistakes. In particular, when an apparatus is configured in which multiple users simultaneously work on a display region whose size ranges from a few tens of inches to a hundred and several tens of inches, it is expected that each user may have difficulty in reaching his/her hand to a dragging destination or in finding an icon at a dragging destination. According to the exemplary embodiment, even in such cases, drag and drop operations become easier.

In a notebook PC (the body and the display are attached with each other with a hinge), if the display falls down when the user is dragging an icon, the user's finger may be released from the icon. Also, when the user holds a tablet PC with one hand and operates it with the other hand, the holding state of the PC tends to become unstable, and the direction of dragging may be deviated. According to the exemplary embodiment, even in such cases, drag and drop operations become easier.

### Modifications

The above-described exemplary embodiment may be modified as described in the following modifications. Alternatively, the exemplary embodiment may be combined with one or more modifications, or multiple modifications may be combined.

### First Modification

The exemplary embodiment discusses an example in which the approaching display unit 105 executes an approaching display process in response to detection of the third operation after detection of the first operation. Alternatively, the extracting unit 104 may extract a second element in response to detection of the third operation after detection of the first operation. That is, in the flowchart illustrated in FIG. 6, the processing in steps S103 and S104 may be executed prior to step S102.

Alternatively, if the first operation is detected, extraction of a second element and an approaching display process may be performed without detecting the third operation. That is, in step S103, the controller 11 determines whether dragging is stopped, and, if dragging is stopped, the process may proceed to step S105; if dragging is not stopped, the process may proceed to step S104.

### Second Modification

The exemplary embodiment discusses an example in which, as an example of the configuration in which the extracting unit 104 extracts, as a second element, an element corresponding to the attribute of the first element, a folder including an element created by an application program used to create the first element is extracted as a second element. Alternatively, the configuration may be as follows.

For example, when the first element is the icon of a folder, the icon of a folder may be extracted as a second element. In this case, a process of creating a new folder and moving the folder of the first element and the folder at the dropping destination to the interior of the new folder may be assumed as a process performed after dropping.

Alternatively, when the first element is the icon of a file, the icon of an execution file may be extracted as a second element. In this case, the controller 11 executes the execution file, which is the second element, on the basis of the first element serving as input data. The execution file is, for example, an application that generates email to which the first element is attached and sends the email, an application that sends the first element via facsimile, an application that expands the first element if the first element is compressed data, or the like.

When data indicating a person who created the first element is included in the first element, an element created by this creator may be extracted as a second element.

### Third Modification

The exemplary embodiment discusses the configuration in which the extracting unit 104 extracts, as a second element, an element that is positioned in the direction of movement of the first element and that corresponds to the attribute of the first element. Alternatively, the extracting unit 104 may extract, as a second element, an element positioned in the direction of movement of the first element. That is, in this case, an element not corresponding to the attribute of the first element also serves as a target of an approaching display process.

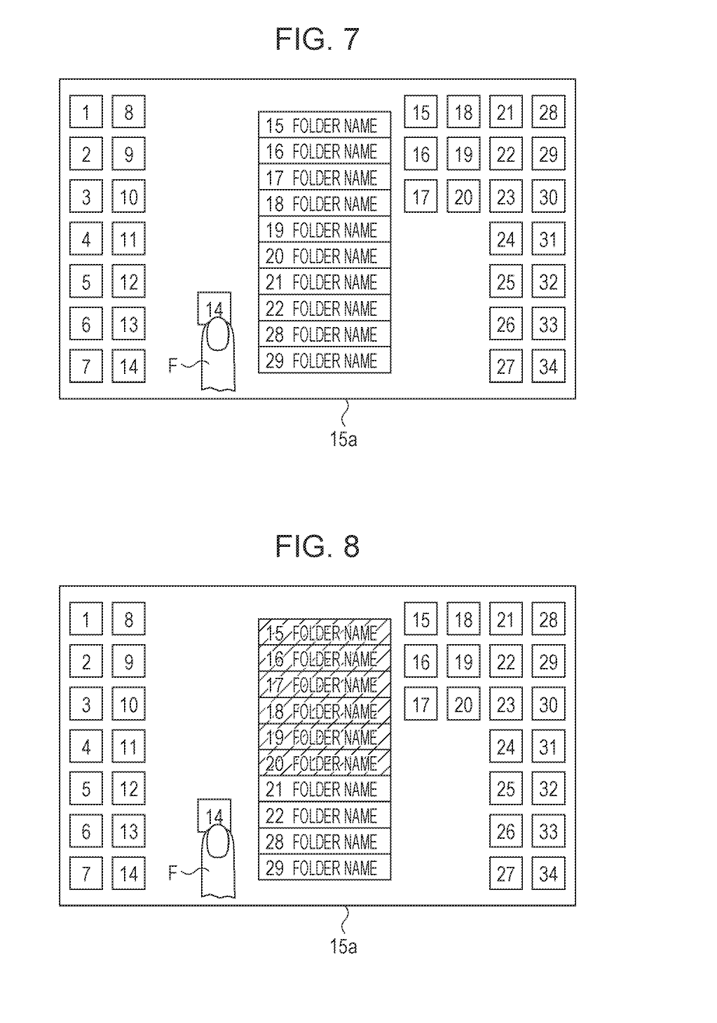

FIG. 7 is a diagram illustrating the arrangement of elements after an approaching display process is performed. As in the exemplary embodiment, the attribute of the first element is the type of application program used to create the first element. When the 15th to 20th elements include elements created by that application program and when the 21st, 22nd, 28th, and 29th elements are not folders but are files, the 15th to 22nd, 28th, and 29th elements are extracted as second elements in the third modification.

The approaching display unit 105 may change the external appearance of, among the third elements, an element corresponding to the attribute of the first element.

FIG. 8 is a diagram illustrating the arrangement of elements after an approaching display process is performed. In this manner, the color of the 15th to 20th elements may be changed. Alternatively, the color before the change and the color after the change may be alternately displayed every second. Alternatively, the 15th to 20th elements may be enlarged and displayed, or the 15th to 20th elements may be displayed at positions closer to the first element than the 21st, 22nd, 28th, and 29th elements.

### Fourth Modification

When a forth element not displayed in the display region 15a is associated with a second element as an element that belongs to the second element, the fourth element and a third element may be associated with each other and displayed in the display region 15a.

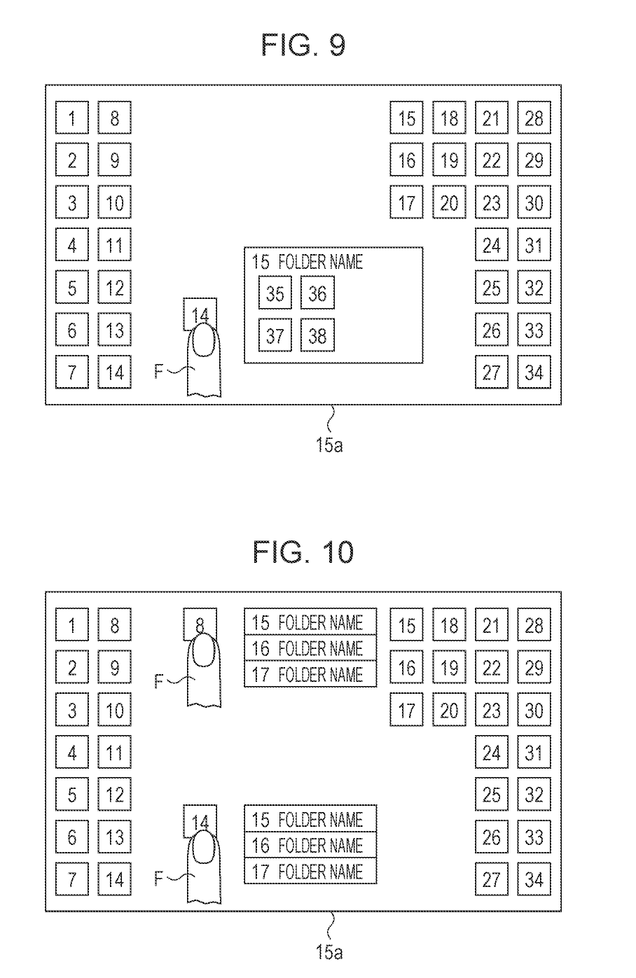

FIG. 9 is a diagram illustrating the arrangement of elements after an approaching display process is performed. In this example, the 15th element is extracted as a second element, and the 35th to 38th elements are associated, as fourth elements, with the second elements. In this case, a duplicate of the 15th element is generated as a third element, this third element is displayed as a window, and the 35th to 38th elements are displayed in this window. Alternatively, the third element may remain unchanged and may be displayed as an icon, and the fourth elements may be displayed adjacent to this icon.

### Fifth Modification

When the first operation is individually performed on each of multiple first elements, and when the extracting unit 104 extracts the same second elements in response to these multiple first operations, the approaching display unit 105 may generate third elements corresponding to the number of these first operations, and may display the third elements at positions closer to the first elements than the second elements.

FIG. 10 is a diagram illustrating the arrangement of elements after an approaching display process is performed. In this example, the 14th element (first element) and the 8th element (first element) are dragged by different users, and the 15th to 17th elements are extracted as second elements of these first elements. In this case, two sets of duplicates of the 15th to 17th elements are generated as third elements, and the generated sets of third elements are displayed at positions closer to their first elements than their second elements.

### Sixth Modification

The extracting unit 104 may extract a second element on the basis of the direction and speed of movement of the first element. That is, θ indicated in FIG. 4 is changed in accordance with the speed of movement. For example, the faster the speed of movement, the smaller θ becomes. Alternatively, the faster the speed of movement, the longer the distance between the first element and an element to be extracted.

### Seventh Element

The extracting unit 104 may extract a second element on the basis of the direction and distance of movement of the first element. The distance of movement is the distance of movement from the start of dragging to the end of dragging. For example, the longer the distance of movement, the smaller θ becomes. Alternatively, the longer the distance of movement, the longer the distance between the first element and an element to be extracted.

### Eighth Modification

The direction of movement of the first element may be the direction of a line segment connecting the position at which dragging is started (start point) and the position at which dragging is stopped (end point), or the direction of a tangent at the end point of the path of movement of the first element.

### Ninth Modification

The exemplary embodiment discusses an example in which the first element is specified by the user by touching the display region 15a. Alternatively, another system in which the first element is specified without touching the display region 15a may be used. For example, a system in which the position of the user's finger or a pen is specified by using an infrared ray or the like may be used, or a system in which a position indicated by the user's finger, face, eyeball, or the like is specified by capturing an image of the finger, face, eyeball, or the like and analyzing the image may be used.

Although the exemplary embodiment discusses an example in which a touch panel is used, a system in which the first element is specified by using a mouse or a joystick may be used.

### Tenth Modification

The third operation may be an operation other than that discussed in the exemplary embodiment. For example, the third operation may be an operation in which, after dragging is stopped, the user taps the background with a different finger without releasing the finger touching the first element.

Alternatively, a menu may be displayed in a state in which dragging is stopped. For example, a popup menu including items such as “approaching display process” and “cancel” may be displayed, and the user may tap a desired item.

### Eleventh Modification

The exemplary embodiment discusses an example in which the extracting unit 104 extracts an element positioned in a fan-shaped range, around the end point of arrow A in FIG. 4, at an angle θ on both sides of extension B of arrow A. Alternatively, the extracting unit 104 may extract an element positioned in a belt-shaped range sandwiched between two straight lines distant from extension B by a predetermined distance.

### Twelfth Modification

The exemplary embodiment discusses, as an example of the image forming apparatus 10, an example in which all the hardware items are provided in the housing 19. Alternatively, the information processing apparatus 10 may be a notebook PC in which a housing including the display 15 and a housing including hardware items other than the display 15 are attached to each other with a hinge. Alternatively, the information processing apparatus 10 may include hardware other than the display 15, and the information processing apparatus 10 and the display 15 (display apparatus) may be connected by signals or wireless communication units.

### Thirteenth Modification

The exemplary embodiment discusses an example in which the information processing apparatus 10 operates when the controller 11 of the information processing apparatus 10 executes the application program. Alternatively, the same or similar functions as those in the exemplary embodiment may be implemented in hardware on the information processing apparatus 10. Alternatively, the program may be provided by being recorded on a computer readable recording medium, such as an optical recording medium or a semiconductor memory, and the program may be read from the recording medium and stored in the memory 12 of the information processing apparatus 10. Alternatively, the program may be provided via an electric communication line.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a display that displays an image including the arrangement of a plurality of elements on a display region of a display apparatus;
a detector that detects an operation performed in the display region;
a moving unit that moves, in response to detection, by the detector, of a first operation in which a first element specified in the display region, among the elements displayed in the display region, is moved in the display region, the first element in the display region in accordance with the first operation;
an extracting unit that extracts, from among the elements displayed in the display region, a second element positioned in the direction of movement of the first element;
an approaching display unit that generates a third element relating to the second element and displays the third element at a position closer to the first element than the second element; and
an element processor that executes, in response to detection, by the detector, of a second operation performed on the third element, a process corresponding to the second operation on the second element.

2. The information processing apparatus according to claim 1, further comprising an erasing unit that erases the third element after the process corresponding to the second operation is executed.

3. The information processing apparatus according to claim 1, wherein the extracting unit extracts, as the second element, an element that is positioned in the direction of movement of the first element and that corresponds to the attribute of the first element.

4. The information processing apparatus according to claim 1, wherein the approaching display unit changes the external appearance of, of the third element, an element corresponding to the attribute of the first element.

5. The information processing apparatus according to claim 1, wherein, when a fourth element not displayed in the display region is associated with the second element as an element that belongs to the second element, the approaching display unit associates the fourth element with the third element, and displays the fourth element in the display region.

6. The information processing apparatus according to claim 1, wherein, when the first operation is individually performed on a plurality of first elements and when the extracting unit extracts the same second element in response to the plurality of first operations, the approaching display unit generates third elements corresponding to the number of the plurality of first operations, and displays each of the third elements at a position closer to a corresponding one of the plurality of first elements than the second element.

7. The information processing apparatus according to claim 1, wherein, in response to detection, by the detector, of a third operation subsequent to detection, by the detector, of the first operation, the approaching display unit generates the third element, and displays the third element at a position closer to the first element than the second element.

8. The information processing apparatus according to claim 1, wherein the extracting unit extracts the second element on the basis of the direction and speed of movement or the direction and distance of movement of the first element.

9. An image processing method comprising:
displaying an image including the arrangement of a plurality of elements on a display region of a display apparatus;
detecting an operation performed in the display region;
moving, in response to detection of a first operation in which a first element specified in the display region, among the elements displayed in the display region, is moved in the display region, the first element in the display region in accordance with the first operation;
extracting, from among the elements displayed in the display region, a second element positioned in the direction of movement of the first element;
generating a third element relating to the second element and displaying the third element at a position closer to the first element than the second element; and
executing, in response to detection of a second operation performed on the third element, a process corresponding to the second operation on the second element.

10. An information processing apparatus comprising:
a touch panel that displays a plurality of icons in a display region and detects an operation performed in the display region;
a moving unit that selects and moves a first icon displayed in the display region in accordance with an operation performed by a user;
an extracting unit that extracts a second icon positioned in the direction of movement of the first icon;
an approaching display unit that generates a third icon relating to the second icon, and displays the third icon at a position closer to the first icon than the second icon; and
a processor that executes, in response to dropping of the first icon to the third icon, a process to be executed in response to dropping of data indicated by the first icon to the second icon.
